(19) United States
(12) Patent Application Publication
(10) Pub. No.: US 2017/0082985 A1
(43) Pub. Date: Mar. 23, 2017

(54) OPTIMIZING EQUIPMENT USAGE

(71) Applicant: INTERNATIONAL BUSINESS MACHINES CORPORATION, Armonk, NY (US)

(72) Inventors: JAMES ROBERT KOZLOSKI, New Fairfield, CT (US); TIMOTHY MICHAEL LYNAR, St Kew (AU); SURAJ PANDEY, Parkville (AU); JOHN MICHAEL WAGNER, Plainville, CT (US)

(21) Appl. No.: 14/858,403

(22) Filed: Sep. 18, 2015

(51) Int. Cl. G05B 13/02

(52) U.S. Cl. CPC G05B 13/021

(57) ABSTRACT

A method of optimizing equipment usage in a network includes determining wear of a first machine in the network. A state of a second machine in the network is determined. When the second machine will be available for use with the first machine is determined based on the state of the second machine. A state of the first machine is recorded. Optimal usage criteria for the first machine is determined based on when the second machine will be available, the recorded state of the first machine and the wear of the first machine. The optimal usage criteria is provided to the first machine. The first machine is monitored after its has received the optimal usage criteria.

### TECHNICAL FIELD

The present invention relates to equipment usage, and more specifically, to systems and methods for optimizing equipment usage.

### DISCUSSION OF THE RELATED ART

Large mining equipment is expensive to purchase, operate and maintain. Such mining equipment is typically equipped with key performance indicators which indicate how a machine is performing a given task. For example, a machine that digs the earth includes a key performance indicator that indicates the time it took for an operator to perform a particular task. Thus, the operator is motivated to operate the digging machine at high power level to achieve good key performance indicators.

Mining operations are complex operations that involve numerous locations, machinery, and people. When a digging machine operator operates the machine at a high power level to increase the key performance indicators of the machine (e.g., that the machine took less time to dig a given amount of material because it was operating a high power level), the digging machine experiences increased wear and tear due to being operated at the high power level. However, if a dump truck is not ready to be loaded with the dug material when the digging machine has finished digging, the time savings realized by the faster digging are lost and the digging machine experienced increased wear and tear.

### SUMMARY

According to an exemplary embodiment of the present invention, a method of optimizing equipment usage in a network includes determining wear of a first machine in the network. A state of a second machine in the network is determined. When the second machine will be available for use with the first machine is determined based on the state of the second machine. A state of the first machine is recorded. Optimal usage criteria for the first machine is determined based on when the second machine will be available, the recorded state of the first machine and the wear of the first machine. The optimal usage criteria is provided to the first machine. The first machine is monitored after its has received the optimal usage criteria.

In an exemplary embodiment of the present invention, the wear of the first machine is determined from data obtained from a plurality of components of the first machine.

In an exemplary embodiment of the present invention, the state of the second machine includes a location or operating status of the second machine.

In an exemplary embodiment of the present invention, the state of the first machine includes location or operating status of the first machine.

In an exemplary embodiment of the present invention, the method of optimizing equipment usage in a network further includes instructing the first machine or an operator of the first machine to operate the first machine in accordance with the optimal usage criteria.

In an exemplary embodiment of the present invention, the instruction is wirelessly provided to the first machine or the operator of the first machine.

In an exemplary embodiment of the present invention, the wear of the first machine corresponds to gradual impairment of the first machine from use.

In an exemplary embodiment of the present invention, data associated with the wear of the first machine is wirelessly provided from the first machine to an external source.

In an exemplary embodiment of the present invention, the state of the second machine is wirelessly provided from the second machine to an external source.

In an exemplary embodiment of the present invention, the optimal usage criteria is wirelessly provided from an external source to the first machine.

In an exemplary embodiment of the present invention, the first and second machines include earthmoving or mining equipment.

According to an exemplary embodiment of the present invention, a method of optimizing equipment usage in a network includes receiving data from a second machine on which an action of a first machine is dependent. A time point when the second machine will complete the action on which the first machine is dependent is estimated by using the data received from the second machine. Data from the first machine indicating its current operating state is received. An optimal action to get the first machine in a desired state to reduce wear of the first machine is determined, wherein the optimal action is determined by using the estimated time point when the second machine will complete the action on which the first machine is dependent and the current operating state of the first machine. The optimal action is output.

In an exemplary embodiment of the present invention, the optimal action is provided to a behavior modification system included in the first machine.

In an exemplary embodiment of the present invention, the optimal action includes operator actions required to get the first machine in the desired state.

In an exemplary embodiment of the present invention, when the first machine is being operated in response to the optimal action, the method further comprises providing the operator with corrective feedback when there is a deviation from the operator actions required to get the first machine in the desired state.

In an exemplary embodiment of the present invention, the corrective feedback is based on recording actual operator actions taken after the optimal action is provided to the behavior modification system included in the first machine, and determining a difference between the actual operator actions and the operator actions required to get the first machine in the desired state.

According to an exemplary embodiment of the present invention, a system for optimizing equipment usage in a network includes a first computer communicatively coupled to a first set of monitoring devices including a first torque sensor, a first accelerometer, a first speed sensor, a first load sensor, a first temperature detector, a first fuel meter, or a first Global Positioning System (GPS) device disposed on a first machine. A second computer is communicatively coupled to a second set of monitoring devices including a second torque sensor, a second accelerometer, a second speed sensor, a second load sensor, a second temperature detector, second a fuel meter, or a second GPS device disposed on a second machine. A third computer is configured to receive data from the second computer to determine a state of the second machine, to determine when the second machine will be available for use with the first machine based on the data received from the second computer, to record a current operating state of the first machine using data from the first computer, to determine an optimal action to get the first machine in a desired state to reduce wear of the first machine, wherein the optimal action is determined based on when the second machine will be available, wear states of the first machine, and the current operating state of the first machine, and to output the optimal action to the first computer.

In an exemplary embodiment of the present invention, the first computer further includes a behavior modification system configured to instruct an operator of the first machine to perform the optimal action.

In an exemplary embodiment of the present invention, the optimal action includes operator actions required to get the first machine in the desired state.

In an exemplary embodiment of the present invention, the first and second machines include earthmoving or mining equipment.

### BRIEF DESCRIPTION OF THE DRAWINGS

The above and other features and aspects of the inventive concept will become more apparent by describing in detail exemplary embodiments thereof with reference to the accompanying drawings, in which:

FIG. 1 illustrates a flowchart of a method of maximizing equipment usage and productivity, according to an exemplary embodiment of the present invention;

FIG. 2 illustrates a block diagram of a system for optimizing a performance of a machine, according to an exemplary embodiment of the present invention;

FIG. 3 illustrates a block diagram of a portion of the system for optimizing a performance of a machine shown in FIG. 2, according to an exemplary embodiment of the present invention; and

FIG. 4 illustrates an example of a computer system capable of implementing the method and apparatus according to embodiments of the present disclosure.

### DETAILED DESCRIPTION OF THE EMBODIMENTS

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The flowcharts and/or block diagrams in the figures illustrate the architecture, functionality, and operation of possible implementations of systems, methods, and computer program products according to various exemplary embodiments of the inventive concept. In this regard, each block in the flowchart or block diagrams may represent a module, segment, or portion of instructions, which comprises one or more executable instructions for implementing the specified logical function(s). In alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The productivity of a network of a plurality of machines depends on the work done by the individual machines that make up the network of machines and on the coordination of work among the machines. For example, when a first machine performs a first task rapidly and finishes the first task ahead of a scheduled time, the productivity of the first machine is high. However, when the first machine depends on a second machine doing something before the first machine can perform a second task, and the second machine is not available to perform when needed by the first machine, the time savings and the increased productivity realized by the first machine in performing the first task quickly are wasted. Accordingly, the productivity of the network of machines was not increased. Further, the wear and tear accumulated in the first machine could have been reduced by slowing it down to finish the first task when the second machine would have been ready to perform.

In exemplary embodiments of the present invention, the network of machines includes a plurality of machines. A state of all machines of the network of machines is monitored in real-time. A computer can determine the state of each machine at a given point in time. For example, a first machine may be digging the earth at a pace of 1 ton of earth material per hour, and that the first machine has already dug 5 tons of earth material. A second machine may be a machine that will transport the dug material away from the first machine and may be monitored. Based on the states of the machines, in this case based on the states of the first and second machines, the computer can determine when the second machine will become available to pick up the material that the first machine has dug. When a task to be performed by the first machine depends on an action being performed by a second machine, the computer can determine an optimal operational state of each machine in the network of machines (e.g., the work pace of each machine) given the state of the machines, and by considering reducing wear and tear to the machines. For example, if the second machine is needed to pick up the material that the first machine dug before the first machine can continue digging, and the second machine will be delayed in picking up the material while traveling at the current speed, the first machine can be slowed down or turned off, the second machine can be sped up to arrive at the digging site earlier, or the first machine can be slowed down while the second machine is sped up. Accordingly, the productivity of the network of machines is increased while wear and tear of the machines may be decreased.

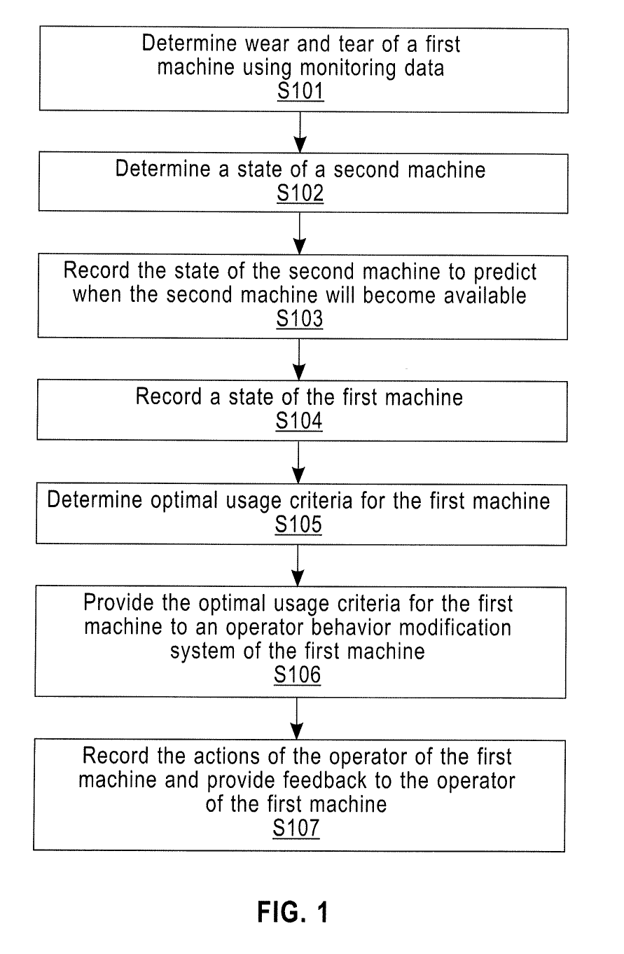

FIG. 1 illustrates a flowchart of a method of maximizing equipment usage and productivity, according to an exemplary embodiment of the present invention.

A network of machines may include a plurality of machines. Referring to FIG. 1, in step S101, wear and tear of each machine of the network of machines can be determined using monitoring data obtained from each machine using a plurality of sensors. The monitoring data may include data obtained by sensors disposed on each machine. The sensors may monitor the motor of the machine or other parts of the machine. For example, the sensors disposed on a first machine may monitor the speed of the first machine, the load that the first machine is carrying, and the like. The sensors can provide real-time monitoring data. For example, the sensors can provide real-time monitoring data at a rate of 1/10 second. The sensors may include a torque sensor, an accelerometer, a speed sensor, a temperature detector, a load sensor, a fuel meter, or the like. The torque sensor can monitor a torque of a motor of the first machine. The accelerometer can monitor an acceleration of the first machine. The speed sensor can monitor a speed of the first machine. The temperature detector can determine the temperature of the motor of the first machine. The load sensor can determine a load which the first machine is carrying. The fuel meter can determine the fuel level of the first machine.

In an exemplary embodiment of the present invention, the wear and tear of the first machine of the network of machines can be determined, or estimated, in step S101 using monitoring data. Wear and tear of the first machine (e.g., wareforce) can be estimated, for example, by calculating a momentum of the first machine that is, for example, stopping, and dividing the calculated momentum by the distance it took for the first machine to stop. For example, Wareforce=Momentum/Stopping Distance. The momentum of the first machine is calculated by multiplying the mass of the first machine with the velocity of the first machine. For example, Momentum=mass*velocity. The first machine may be, for example, a dump truck. The wear and tear of dump truck can be determined, or estimated, for example, when a load on the dump truck is known (e.g., measured by the load sensor), a speed of the dump truck is known (e.g., measured by the speed sensor), and a stopping distance of the dump truck is known (e.g., measured using the speed sensor or manually measured). In this example, given the load, speed, and stopping distance, the wear and tear of the dump truck and/or of its components can be determined. For example, the wear and tear of the motor and the wear and tear of the brakes can be determined using the load, speed, and stopping distance of the dump truck. However, the present invention is not limited thereto. The first machine may be any type of machine, for example, a human-operated machine, or a self-operated machine.

The state of each machine in the network of machines can be obtained in step S102. In an exemplary embodiment of the present invention, the state of a second machine in the network of machines is obtained in step S102. The state of the second machine may include data such as, for example, the location of the second machine, whether the second machine is operating or is out of service, and monitoring data such as the speed of the second machine, the load that the second machine is carrying, and the like. For example, the second machine may be a dump truck that is located 20 miles away from a mine, is traveling toward the mine at a rate of 25 miles per hour, and the like. In other words, the state of the second machine obtained in step S102 includes where the second machine is and what it is doing.

In step S103, a state of each machine in the network of machines may be recorded to predict when each machine will be available to perform a given action at a given location. In an exemplary embodiment of the present invention, in step S103, the state of the second machine obtained in step S102 is recorded to predict when the second machine will become available to perform a given action at a given location. For example, the state of the dump truck is recorded to determine when the dump truck will arrive at a mine. When the location, travel direction, and speed of the dump truck are known, the time in which the dump truck will arrive at the mine can be determined. In other words, the time when the second machine will become available can be estimated based on the known position and speed of the second machine. In addition, monitoring data of the second machine can be used to determine the state of the second machine. For example, load sensor data of the dump truck may indicate that the dump truck is empty.

In step S104, a state of each machine of the network of machines is recorded. In an exemplary embodiment of the present invention, a state of the first machine at a given point in time is recorded is step S104. The state of the first machine may include whether the first machine is out of service, running, idle, performing a task and if so what percentage of the task is complete. In addition, the state of the first machine may include real-time monitoring data. For example, the first machine may be a shovel and bucket. The shovel and bucket may be a machine that loads earth material using a shovel into a bucket that can carry 10 tons of earth material. The status of the shovel and bucket may be, for example, that the shovel is idle and the bucket is empty, that the shovel is working and the bucket is loaded with 8 tons of material, that the shovel is idle and the bucket is full and waiting to dump the dug material into a dump truck, or the like.

In step S105, optimal usage criteria may be determined for each machine in the network of machines. In an exemplary embodiment of the present invention, optimal usage criteria for the first machine is calculated in step S105 using the predicted time and place where the second machine will become available to perform, determined in step S103, and the state of the first machine, recorded in step S104. In addition, optimal usage criteria for the first machine is calculated by considering minimizing the wear and tear of the first and second machines. The speed, force, torque, a acceleration, and the like, at which the first machine needs to be operating with at a second state (e.g., an optimal state) is determined. For example, the first machine may be the shovel and bucket. The shovel may be loading earth material at a first speed, and the bucket may be loaded with 5 tons of the material and have a maximum load capacity of 10 tons. The shovel may be loading the bucket, for example, at a speed of 2.5 tons per hour. Thus, the remaining 5 tons capacity of the bucket will be loaded in 2 hours at the current shovel loading speed. However, when the second machine is, for example, a dump truck in which the bucket will dump the 10 tons of material, and the dump truck is determined to arrive at the location of the shovel and bucket in 3 hours, the loading speed of the shovel may be slowed down so the shovel and bucket will be ready to dump into the dump truck when the dump truck is determined to arrive. Thus, wear and tear of the shovel and bucket may be reduced by reducing the speed in which the shovel loads the bucket.

In step S105, an optimal productivity state of the first machine is determined by considering that productivity is reduced when the operators of the first and second machines work slowly and operate the first and second machines slowly, and that wear and tear of the components of the first and second machines needs to be minimized. In some cases, when optimizing the usage criteria (e.g., determining the optimal productivity state) for, for example, the first machine, the first machine may be operated at high speeds and/or heavy loads when the second machine is waiting (e.g., idling) for the first machine to finish its current task. For example, the cost associated with waiting a long time for the first machine to finish its current task at its current slow speed (e.g., costs associated with idling the second machine, the unproductive time of the operator of the second machine while the second machine is idling, and other impacts on the network of machines caused by the delay of the second machine) may be greater than the costs associated with the wear and tear caused to the first machine by operating it at high speed and/or load. The optimization usage criteria can be constantly updated for the first machine. According to an exemplary embodiment of the present invention, the optimization usage criteria can be constantly updated for each machine in the network of machines.

In step S106, the optimal usage criteria determined for each machine in the network of machines may be provided to an operator behavior modification system included in each respective machine. In an exemplary embodiment of the present invention, in step S106, the optimal usage criteria for the first machine, determined in step S105, is provided to an operator behavior modification system of the first machine to calculate the operator actions that need be performed to operate the first machine according to the optimal usage criteria determined for the first machine in step S105. The operator behavior modification system may be a computer disposed on the first machine. The operator behavior modification system can provide to the operator of the first machine the steps needed to change the state of the first machine from its current state to the optimal state determined in step S105. For example, when the first machine is currently digging at a speed 2.5 tons per hour, and in step S105 the optimal state of the machine is determined to be that the first machine should dig at a speed of 2 tons per hour, the operator behavior modification system can provide instructions to the operator of the first machine to slow down the digging speed of the machine to 2 tons per hour.

The operator behavior modification system may provide instructions to the operator of the first machine by a text message delivered to a display device of the first machine, by directing synthesized speech to the operator using a loudspeaker disposed on the first machine (e.g., the synthesized speech may be a computer speech audibly reading the content of the instructions to the operator), or by sounding an alarm.

In step 107, actions that each operator of each respective machine takes are recorded. In an exemplary embodiment of the present invention, in step S107, actions that the operator of the first machine takes are recorded. For example, the actions of the operator of the first machine may be continuously recorded. The recorded actions of the operator of the first machine are compared with the steps provided by the operator behavior modification system to the operator of the first machine to get the first machine into the optimal state determined in step S105. When there is a deviation from the operator actions required to get the first machine into the optimal state determined in step S105, corrective feedback (e.g., further action steps) may be provided to the operator of the first machine by text messages, synthesized speech, or the like, to get the first machine into the optimal state determined in step S105. Two machines are described herein for convenience of explanation. However, it can be understood that numerous upstream and downstream machines and their states are involved in the optimization computation.

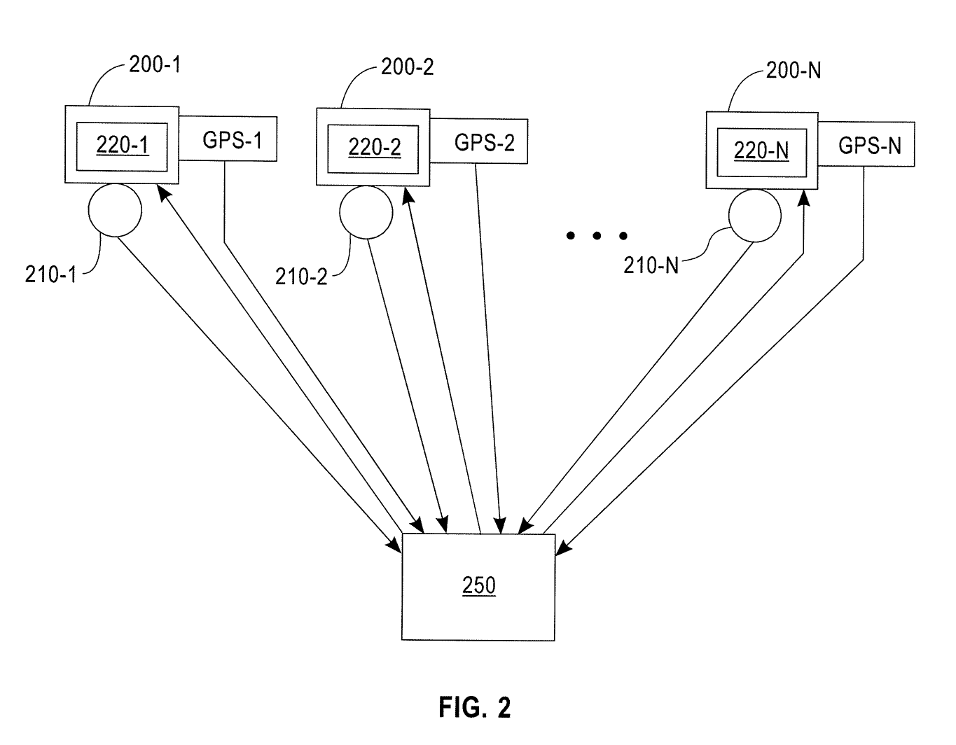

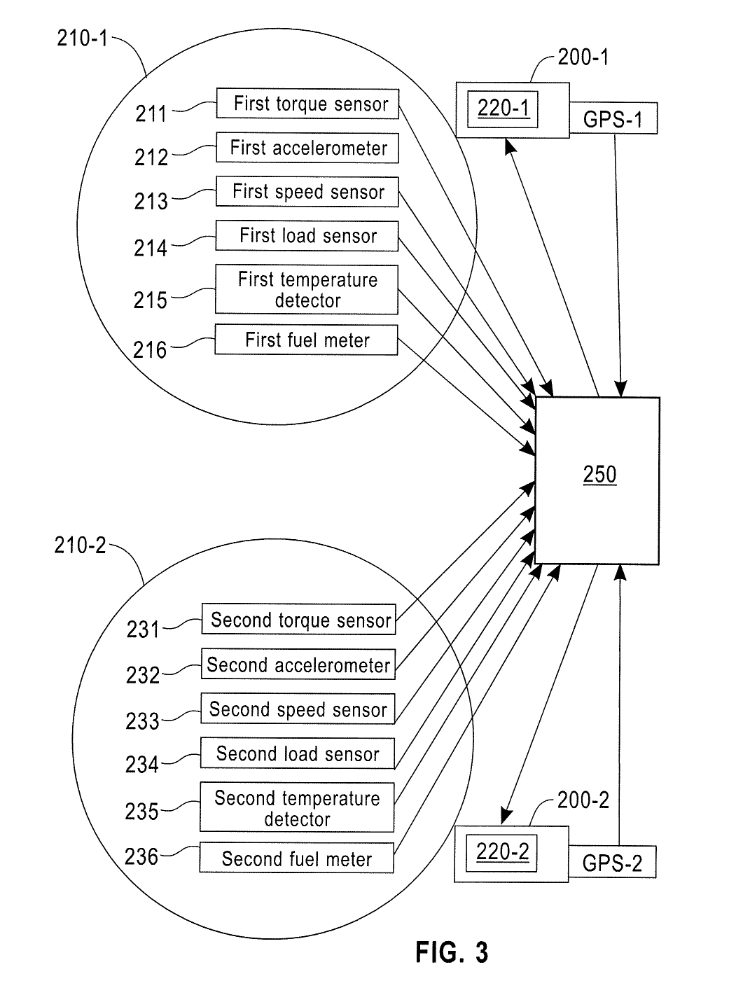

FIG. 2 illustrates a block diagram of a system for optimizing a performance of a machine, according to an exemplary embodiment of the present invention. FIG. 3 illustrates a block diagram of a portion of the system for optimizing a performance of a machine shown in FIG. 2.

Referring to FIG. 2, the system for optimizing a performance of a machine includes a plurality of machines. The plurality of machines includes a first machine 200-1, and a second machine 200-2 to an N-th machine 200-N. Each of the first to N-th machines 200-1 to 200-N may include a plurality of sensors. The first to N-th machines 200-1 to 200-N may be operated by a user or may be operated by a computer. According to an exemplary embodiment of the present invention, the first and second machine machines 200-1 and 200-2 may include earthmoving and mining equipment.

The first machine 200-1 may include a first plurality of sensors 210-1, the second machine 200-2 may include a second plurality of sensors 210-2, and the Nth machine 200-N may include an N-th plurality of sensors 210-N. Each of the first to N-th plurality of sensors 210-1 to 210-N may include a plurality of sensors such as, for example, a torque sensor, an accelerometer, a speed sensor, a load sensor, a temperature detector, a fuel meter, and the like. However, the present invention is not limited to the above-disclosed sensors. For example, a machine among the first to N-th machines 200-1 to 200-N may include a light detecting sensor, an infrared sensor, a carbon monoxide sensor, a barometer, an altimeter, and the like.

Each sensor of the first to N-th plurality of sensors 210-1 to 210-N may be communicatively coupled with a computer 250 to transmit monitoring data to the computer 250 via a wired or wireless connection. The first to N-th plurality of sensors 210-1 to 210-N may transmit real-time monitoring data to the computer 250. The real-time monitoring data may be refreshed at a rate of for example, 1/10 seconds, and may include the state of each respective machine, among the first to N-th machines 200-1 to 200-N. Referring to FIG. 3, the first plurality of sensors 210-1 may include a first torque sensor 211, a first accelerometer 212, a first speed sensor 213, a first load sensor 214, a first temperature detector 215, and a first fuel meter 216. The second plurality of sensors 210-2 may include a second torque sensor 231, a second accelerometer 232, a second speed sensor 233, a second load sensor 234, a second temperature detector 235, and a second fuel meter 236. The present invention is not limited to the sensors listed above. For example, one or more machines among the plurality of machines 200-1 to 200-N may include additional sensors or fewer sensors than the sensors listed above.

The plurality of machines 200-1 to 200-N, respectively, may include a first computer 220-1 to an N-th computer 220-N. For example, the second machine 200-2 may include a second computer 220-2. The present invention is not limited to the computers listed above. For example, one or more machines among the plurality of machines 200-1 to 200-N may not include a computer.

The plurality of machines 200-1 to 200-N, respectively, may include a first Global Positioning System (GPS) device GPS-1 to an N-th GPS device GPS-N. For example, the second machine 200-2 may include a second GPS device GPS-2. Each of the first to N-th GPS devices GPS-1 to GPS-N may be communicably coupled with the computer 250 to transmit to the computer 250 location data on the respective first to N-th machines 200-1 to 200-N. The present invention is not limited to the GPS devices listed above. For example, one or more machines among the plurality of machines 200-1 to 200-N may not include a GPS device.

The computer 250 may be disposed, for example, in a machine from among the first to N-th machines 200-1 to 200-N, in a room in the mine, in a safe location in the mine, outside of the mine, or in the cloud. Data of the computer 250 may be accessible with a hand held computing device such as a phone or tablet.

The computer 250 may include data regarding a start time and a completion time of each task that each machine among the first to N-th machines 200-1 to 200-N is assigned to perform. The computer 250 may determine if a given machine or if a plurality of machines among the first to N-th machines 200-1 to 200-N are deviating from the start and/or completion times set for each respective machine using a status of each individual machine and real-time monitoring data obtained by the plurality of sensors for each individual machine. The computer 250 may determine an optimal state (e.g., location, speed, torque, power level, and the like) for each machine among the first to N-th machines 200-1 to 200-N by considering reducing wear and tear to each machine, increasing the productivity of each machine, decreasing idling of each machine, avoiding having the machines operate at a low power, and the like, to increase the productivity of the network of the first to N-th machines 200-1 to 200-N.

The system for optimizing a performance of a machine, described with reference to FIGS. 2 and 3, can be used to implement the method steps of the of the method of maximizing equipment usage and productivity, described with reference to FIG. 1. The method steps of the method described with reference to FIG. 1 can be performed by the computer 250. The computer 250 may perform the method steps described with reference to FIG. 1, for example, by using a Mixed Integer Optimization Program.

An optimized state can be determined for each of the first to N-th machines 200-1 to 200-N by the computer 250 using the method steps described with reference to FIG. 1. The computer 250 may be communicatively coupled with each of the first to N-th machines 200-1 to 200-N via a wire or wireless connection to transmit to the first to N-th machines 200-1 to 200-N the respective optimized states (e.g., data indicating what speed, torque, power, acceleration, and the like, the respective machine should be operating with).

When a machine among the first to N-th machines 200-1 to 200-N is operated by a human operator, the optimized state data may be sent to an operator behavior modification system that may be included in the respective machine. The operator behavior modification system may be system included in the computer of the respective machine, among the first to N-th computers 220-1 to 220-N. The operator behavior modification system may determine the physical steps, for example, actions, that the operator of the machine needs to take to change the state of the machine to the optimal state determined by the computer 250. In addition, the operator behavior modification system may convey the determined physical steps to the respective operator using text messages or sound. Each of the respective first to N-th computer 220-1 to 220-N may include a display device to display text messages to the operator including the actions that the operator needs to take to change the state of the machine to the determined optimal state, a loudspeaker that emits speech to the operator including the actions that the operator needs to take to change the state of the machine to the determined optimal state, and the like. The operator behavior modification system of a first to N-th computer 220-1 to 220-N may continuously monitor the actions of the operator of the first to N-th machines 200-1 to 200-N and may convey to the respective operator additional messages, when needed, to change the state of the machine to that determined by the computer 250.

When a machine, among the first to N-th machines 200-1 to 200-N is not operated by a human operator, (e.g., it is automatically operated by a respective computer among the first to N-th computers 220-1 to 220-N), the computer included in that machine may process the data including the optimal machine state determined by the computer 250 and may automatically control the machine to change its operational state according to the optimal state determined for that machine by the computer 250.

It is understood that the network of machines may include two or more machines and that the system for optimizing a performance of a machine can simultaneously optimize the state of each machine in the network of machines using the machine status and real-time monitoring data obtained by each respective machine.

The system disclosed with reference to FIGS. 2 and 3 may be applied to any network of machines. For example, the network of machines can be mining machinery such as earthmoving and mining equipment including dump trucks, excavators, drilling machines, and the like, used in a mining, construction machinery such as concrete pumps, dump trucks, cranes, and the like, used in construction, logistics machines such as package labeling machines, delivery trucks, cargo airplanes, and the like, used in logistic services, transportation machinery such as freight trains, tractor trailers, busses, passenger trains, and the like, used in transportation, and the like. However, the present invention is not limited thereto. The system disclosed with reference to FIGS. 2 and 3 may be applied to any network of machines in which the actions of a first machine need to be coordinated with the actions of a second machine to increase the productivity of the network of machines and to reduce the wear and tear to both the first and second machines.

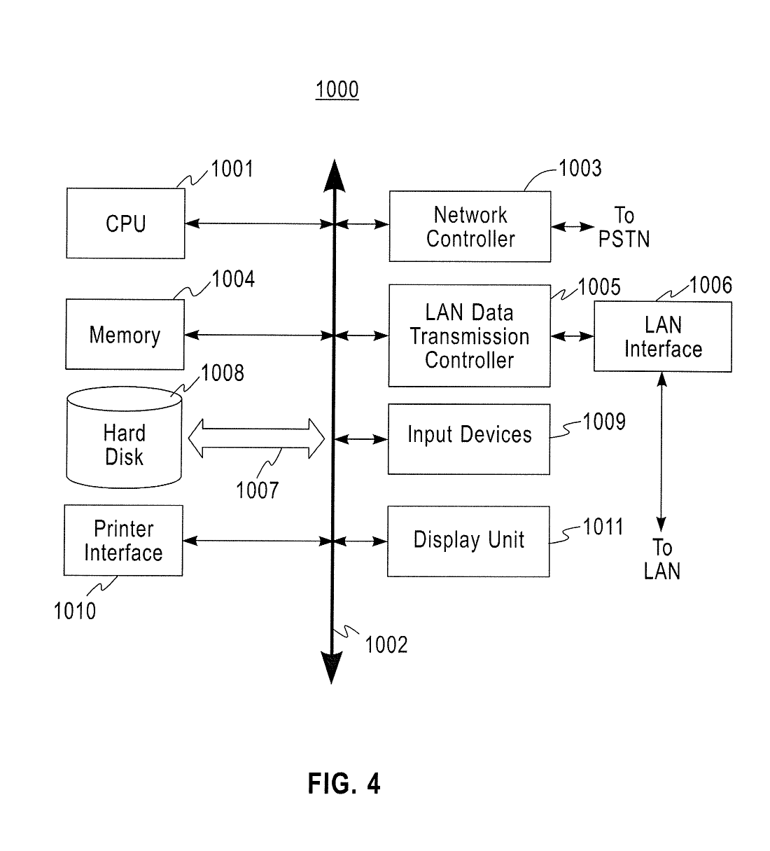

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of optimizing equipment usage in a network, comprising:
determining wear of a first machine in the network;
determining a state of a second machine in the network;
determining when the second machine will be available for use with the first machine based on the state of the second machine;
recording a state of the first machine;
determining optimal usage criteria for the first machine based on when the second machine will be available, the recorded state of the first machine and the wear of the first machine;
providing the optimal usage criteria to the first machine; and
monitoring the first machine after its has received the optimal usage criteria.

2. The method of claim 1, wherein the wear of the first machine is determined from data obtained from a plurality of components of the first machine.

3. The method of claim 1, wherein the state of the second machine includes a location or operating status of the second machine.

4. The method of claim 1, wherein the state of the first machine includes location or operating status of the first machine.

5. The method of claim 1, further comprising instructing the first machine or an operator of the first machine to operate the first machine in accordance with the optimal usage criteria.

6. The method of claim 5, wherein the instruction is wirelessly provided to the first machine or the operator of the first machine.

7. The method of claim 1, wherein the wear of the first machine corresponds to gradual impairment of the first machine from use.

8. The method of claim 1, wherein data associated with the wear of the first machine is wirelessly provided from the first machine to an external source.

9. The method of claim 1, wherein the state of the second machine is wirelessly provided from the second machine to an external source.

10. The method of claim 1, wherein the optimal usage criteria is wirelessly provided from an external source to the first machine.

11. The method of claim 1, wherein the first and second machines include earthmoving or mining equipment.

12. A method of optimizing equipment usage in a network, comprising:
receiving data from a second machine on which an action of a first machine is dependent;
estimating a time point when the second machine will complete the action on which the first machine is dependent by using the data received from the second machine;
receiving data from the first machine indicating its current operating state;
determining an optimal action to get the first machine in a desired state to reduce wear of the first machine, wherein the optimal action is determined by using the estimated time point when the second machine will complete the action on which the first machine is dependent and the current operating state of the first machine; and
outputting the optimal action.

13. The method of claim 12, wherein the optimal action is provided to a behavior modification system included in the first machine.

14. The method of claim 13, wherein the optimal action includes operator actions required to get the first machine in the desired state.

15. The method of claim 14, wherein when the first machine is being operated in response to the optimal action, the method further comprises providing the operator with corrective feedback when there is a deviation from the operator actions required to get the first machine in the desired state.

16. The method of claim 15, wherein the corrective feedback is based on recording actual operator actions taken after the optimal action is provided to the behavior modification system included in the first machine, and determining a difference between the actual operator actions and the operator actions required to get the first machine in the desired state.

17. A system for optimizing equipment usage in a network, comprising:
a first computer communicatively coupled to a first set of monitoring devices including a first torque sensor, a first accelerometer, a first speed sensor, a first load sensor, a first temperature detector, a first fuel meter, or a first Global Positioning System (GPS) device disposed on a first machine;
a second computer communicatively coupled to a second set of monitoring devices including a second torque sensor, a second accelerometer, a second speed sensor, a second load sensor, a second temperature detector, second a fuel meter, or a second GPS device disposed on a second machine; and
a third computer configured to:
receive data from the second computer to determine a state of the second machine;
determine when the second machine will be available for use with the first machine based on the data received from the second computer;
record a current operating state of the first machine using data from the first computer;
determine an optimal action to get the first machine in a desired state to reduce wear of the first machine, wherein the optimal action is determined based on when the second machine will be available, wear states of the first machine, and the current operating state of the first machine; and
output the optimal action to the first computer.

18. The system of claim 17, wherein the first computer further includes a behavior modification system configured to instruct an operator of the first machine to perform the optimal action.

19. The system of claim 18, wherein the optimal action includes operator actions required to get the first machine in the desired state.

20. The system of claim 17, wherein the first and second machines include earthmoving or mining equipment.
